(19) United States
(12) Patent Application Publication
(10) Pub. No.: US 2020/0341110 A1
(43) Pub. Date: Oct. 29, 2020

(54) SIX-PORT SELF-INJECTION-LOCKED RADAR

(71) Applicant: Sil Radar Technology Inc., Kaohsiung City (TW)

(72) Inventors: Fu-Kang Wang, Kaohsiung City (TW); Chan-Hung Lee, Kaohsiung City (TW); Pin-Hsun Juan, Kaohsiung City (TW); Sheng-You Tian, Kaohsiung City (TW)

(21) Appl. No.: 16/793,834

(22) Filed: Feb. 18, 2020

(30) Foreign Application Priority Data
Apr. 26, 2019 (TW) 108114823

(51) Int. Cl. G01S 7/35; G01S 13/34

(52) U.S. Cl. CPC G01S 7/35; G01S 13/34

(57) ABSTRACT

A six-port SIL radar includes an oscillation element, a transceiver element, a power coupling element and a six-port demodulation element. The six-port demodulation element is utilized to demodulate an oscillation signal from the oscillation element such that the operating frequency of the six-port SIL radar will not be restricted by hardware. Further, the power coupling element is configured to divide the oscillation signal into two signals that have equal power when received by the six-port demodulation element for signal-to-noise ratio optimization.

### FIELD OF THE INVENTION

This invention generally relates to a self-injection-locked (SIL) radar, and more particularly to a six-port SIL radar.

### BACKGROUND OF THE INVENTION

Taiwan Patent No. 1493213, entitled “Motion/interference signal detection system and method thereof”, discloses a motion/interference detection system which is a SIL radar. The motion/interference signal detection system is provided to transmit a wireless signal to an object and receive a reflected signal from the object by using a transmitter. The reflected signal is injected into the transmitter such that the motion/interference detection system enters a SIL state to modulate the wireless signal into a frequency-modulated signal, and at the same time, the wireless signal from the transmitter is also received by a receiver of the motion/interference detection system and demodulated to obtain a motion/interference signal of the object. FIGS. 4A, 4B and 4C of Taiwan Patent No. 1493213 show demodulation units of the receivers of different embodiments, and each of the demodulation units in different embodiments includes a mixer unit configured to mix the frequency-modulated signal. Sensitivity and operating frequency of the SIL radar are positively correlated, the higher the operating frequency, the better the sensitivity to tiny vibration. However, the mixer unit of the receiver may be unavailable for higher operating frequency; that is to say, the operating frequency of the SIL radar is restricted by hardware.

### SUMMARY

The object of the present invention is to provide a six-port SIL radar which demodulates signals by using a six-port demodulation element so that the six-port SIL radar can operate at a frequency unrestricted by the mixer and exhibit a substantially enhanced sensitivity.

A six-port SIL radar of the present invention includes an oscillation element, a transceiver element, a power coupling element and a six-port demodulation element. The oscillation element is configured to generate an oscillation signal. The transceiver element is electrically connected to the oscillation element, and configured to transmit the oscillation signal as a transmitted signal to a subject and receive a reflected signal from the subject as a detection signal. The detection signal is configured to be injected into the oscillation element to allow the oscillation element to operate in a self-injection-locked state. The power coupling element is electrically connected to the oscillation element and configured to receive and divide the oscillation signal into a local oscillation signal and a radio frequency signal. The six-port demodulation element is electrically connected to the power coupling element for receiving the local oscillation signal and the radio frequency signal, and configured to demodulate the local oscillation signal and the radio frequency signal to output a demodulated signal. Particularly, the local oscillation signal and the radio frequency signal received by the six-port demodulated element have equal power.

The power coupling element and the six-port demodulation element of the present invention are provided to frequency-demodulate signals to extract the information regarding the movement of the subject such that the operating frequency of the six-port SIL radar will not be limited by demodulation element hardware. Otherwise, for optimizing signal-to-noise ratio of the six-port demodulation element, the power coupling element of the present invention is provided to equal the power of the local oscillation signal and the radio frequency signal received by the six-port demodulation element.

### DESCRIPTION OF THE DRAWINGS

FIG. 1 is a block diagram illustrating a six-port SIL radar in accordance with one embodiment of the present invention.

FIG. 2 is a circuit diagram illustrating a first kind of architecture of an oscillation element and a transceiver element.

FIG. 3 is a circuit diagram illustrating a second kind of architecture of an oscillation element and a transceiver element.

FIG. 4 is circuit diagram illustrating a third kind of architecture of an. oscillation element and a transceiver element.

FIG. 5 is a circuit diagram illustrating a fourth kind of architecture of an oscillation element and a transceiver element.

FIG. 6 is a circuit diagram illustrating a first kind of architecture of a power coupling element.

FIG. 7 is a circuit diagram illustrating a second kind of architecture of a power coupling element.

FIG. 8 is a circuit diagram illustrating a third kind of architecture of a power coupling element.

FIG. 9 is a block diagram illustrating a six-port demodulation element in accordance with one embodiment of the present invention.

FIG. 10 is a circuit diagram illustrating a six-port demodulation element in accordance with one embodiment of the present invention.

### DETAILED DESCRIPTION OF THE INVENTION

With reference to FIG. 1, a six-port SIL radar 100 in accordance with one embodiment of the present invention includes an oscillation element 110, a transceiver element 120, a power coupling element 130 and a six-port demodulation element 140. The oscillation element 110 outputs an oscillation signal S_{O}, the transceiver element 120 is electrically connected to the oscillation element 110, transmits the oscillation signal S_{O} as a transmitted signal S_{T} to a subject O and receives a reflected signal S_{R} from the subject O as a detection signal Sᵣ, finally, the detection signal Sₜ is injected into the oscillation element 110 to form a SIL loop such that the oscillation element 110 operates in a SIL state. Based on the Doppler Effect, the reflected signal S_{R} from the subject O and the detection signal Sᵣ received by the transceiver element 120 contain the Doppler phase shifts caused by the movement of the subject O relative to the six-port SIL radar 100, and the detection signal Sᵣ is injected into the oscillation element 110 to lock the oscillation element 11.0 and frequency-modulate the oscillation signal S_{O} which is output from the oscillation element 110. Accordingly, the information regarding the movement of the subject O can be obtained through frequency demodulation of the oscillation signal S_{O}.

With reference to FIG. 1 again, the power coupling element 130 is electrically connected to the oscillation element 110 to receive the oscillation signal S_{O} which is frequency-modulated by the movement of the subject O. The power coupling element 130 is configured to divide the oscillation signal S_{O} into a local oscillation S_{LO} and a radio frequency signal S_{RF}. The six-port demodulation element 140 is electrically connected to the power coupling element 130 for receiving the local oscillation signal S_{LO} and the radio frequency signal S_{RF}. The six-port demodulation element 140 is configured to demodulate the local oscillation signal S_{LO} and the radio frequency signal S_{RF} to output a demodulated signal S_{d} that contains the information of the movement of the subject O. Preferably, for optimizing the signal-to-noise ratio of the six-port demodulation element 140, the local oscillation signal S_{LO} and the radio frequency signal S_{RF} received by the six-port demodulation element 140 have same power.

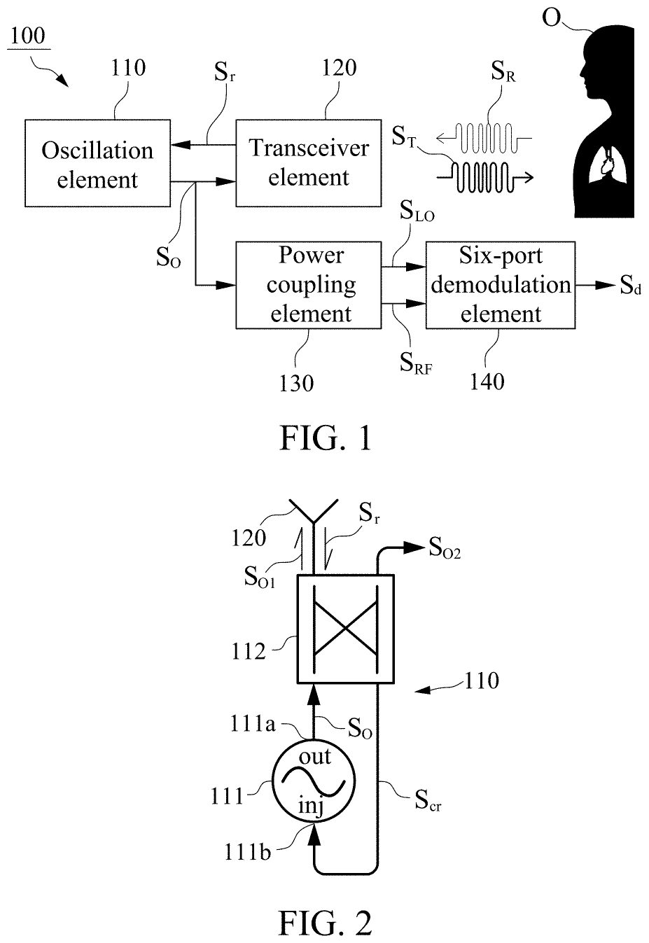

FIG. 2 is a circuit diagram illustrating a first kind of architecture of the oscillation element 110 and the transceiver element 120. The oscillation element 110 includes a voltage-controlled oscillator (VCO) 111 and a coupler 112 which is a hybrid coupler. The VCO 111 is controlled by a control voltage (not shown) to output the oscillation signal S_{O} from an output port 111a. The coupler 112 is electrically connected to the VCO 111 to receive and divide the oscillation signal S_{O} into a first oscillation signal S_{O1} and a second oscillation signal S_{O2}. The transceiver element 120 is a single antenna which is electrically connected to the coupler 112 for receiving the first oscillation signal S_{O1} from the coupler 112. The second oscillation S_{O2} from the other path of the coupler 112 is delivered to the power coupling element 130. The transceiver element 120 transmits the first oscillation signal S_{O1} as the transmitted signal S_{T} to the subject O and receives the reflected signal S_{R} from the subject O as the detection signal Sᵣ. The detection signal Sᵣ is delivered to the coupler 112 and coupled as a coupled detection signal S_{cr} by the coupler 112, and then the coupled detection signal S_{cr} is delivered to the VCO 111 via an injection port 111b such that a loop is formed and the coupled detection signal S_{cr} injected into the VCO 111 allows the VCO 111 to operate in a SIL state.

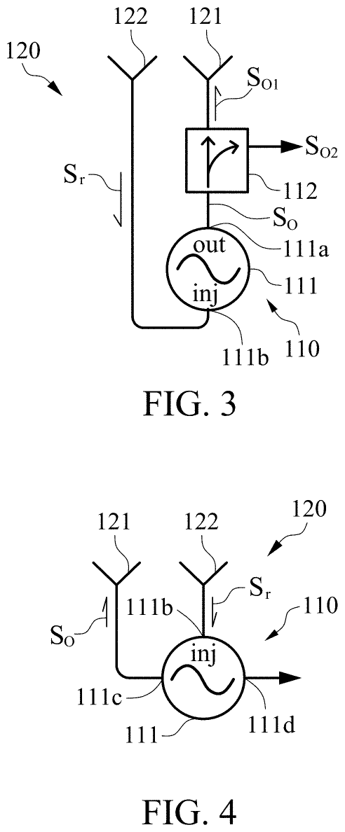

With reference to FIG. 3, it is a circuit diagram illustrating a second kind of architecture of the oscillation element 110 and the transceiver element 120. The oscillation element 110 includes a VCO 111 and a coupler 112, and in this architecture, the coupler 112 is a directional coupler. The VCO 111 outputs the oscillation signal S_{O} from an output port 111a, and the coupler 112 is electrically connected to the VCO 111 and divides the oscillation signal S_{O} into a first oscillation signal S_{O1} and a second oscillation signal S_{O2}. The transceiver element 120 in this architecture includes a transmit antenna 121 and a receive antenna 122, the transmit antenna 121 is electrically connected to the coupler 112 of the oscillation element 110 for receiving the first oscillation S_{O1}. The second oscillation signal S_{O2} from the other path of the coupler 112 is delivered to the power coupling element 130. The transmit antenna 121 transmits the first oscillation signal S_{O1} as the transmitted signal S_{T}, and the receive antenna 122 receives the reflected signal S_{R} as the detection signal Sᵣ. The VCO 111 is electrically connected to the receive antenna 122 via an injection port 111b and thus the detection signal Sᵣ can be injected into to lock the VCO 111.

With reference to FIG. 4, in a third kind of architecture, the oscillation element 110 only includes a VCO 111 having an injection port 111b, a first output port 111c and a second output port 111d, and the transceiver element 120 includes a transmit antenna 121 and a receive antenna 122. The VCO 111 outputs the oscillation signal S_{O} from the first output port 111c and the second output port 111d, the transmit antenna 121 of the transceiver element 120 is electrically connected to the first output port 111c to receive the oscillation signal S_{O}, and the oscillation signal S_{O} from the second output port 111d of the VCO 111 is delivered to the power coupling element 130. The transmit antenna 121 transmits the oscillation signal S_{O} as the transmitted signal S_{T}, and the receive antenna 122 receives the reflected signal S_{R} as the detection signal Sᵣ. The detection signal Sᵣ is injected into the VCO 111 from the injection port 111b which is electrically connected to the receive antenna 122 and thus the VCO 111 is locked.

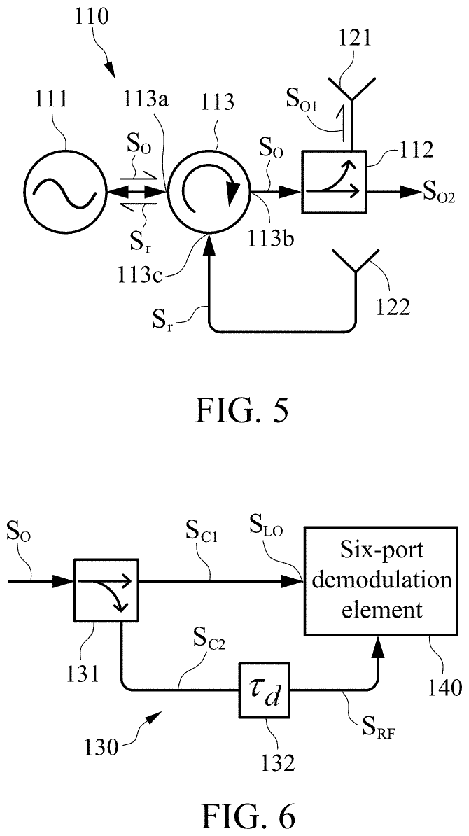

With reference to FIG. 5, the oscillation element 110 includes a VCO 111, a coupler 112 and a circulator 113 and the transceiver element 120 includes a transmit antenna 121 and a receive antenna 122 in a fourth kind of architecture. The circulator 113 has a first port 113a, a second port 113b and a third port 113c, the first port 113a is electrically connected to the VCO 111, the second port 113b is electrically connected to the coupler 112, and the third port 113c is electrically connected to the receive antenna 122. As a result, the coupler 112 and the receive antenna 122 are electrically connected to the VCO 111 via the circulator 113. In this architecture, the oscillation signal S_{O} from the VCO 111 is input into the first port 113a of the circulator 113, output from the second port 113b of the circulator 113 and delivered to the coupler 112, then the coupler 112 divides the oscillation signal S_{O} into a first oscillation signal S_{O1} and a second oscillation signal S_{O2}. The first oscillation signal S_{O1} is delivered to the transmit antenna 121, and the second oscillation signal S_{O2} is delivered to the power coupling element 130. The transmit antenna 121 transmits the first oscillation signal S_{O1} as the transmitted signal S_{T}, the receive antenna 122 receives the reflected signal S_{R} as the detection signal Sᵣ, and the detection signal Sᵣ is delivered to the circulator 113 via the third port 113c and output from the first port 113a to lock the VCO 111.

With reference to FIGS. 1 and 6, there is a first kind of architecture of the power coupling element 130 that includes a directional coupler 131 and a delay unit 132. The directional coupler 131 is electrically connected to the oscillation element 110 and configured to receive and divide the oscillation signal S_{O} into a first coupling signal S_{C1} and a second coupling signal S_{C2}. The first coupling signal S_{O1} is directly delivered to the six-port demodulation element 140 as the local oscillation signal S_{LO}, and the second coupling signal. S_{C2} is delivered to the delay unit 132 which is electrically connected to the directional coupler 131. The second coupling signal S_{C2} is delayed in time as the radio frequency signal S_{RF} by the delay unit 132 and then is delivered to the six-port demodulation element 140. The delay unit 132 may be RC delay circuit, LC delay circuit, delay line, surface acoustic wave filter or injection-locked oscillator. In this architecture, the delay unit 132 s a coaxial cable used as the delay line. During time delay, the power of the second coupling signal S_{C2} is also attenuated by the delay unit 132. Preferably, the second coupling signal S_{C2} from the directional coupler 131 has a power higher than that of the first coupling signal S_{C1} from the directional coupler 131, and a power difference between the second coupling signal S_{C2} and the first coupling signal S_{C1} is substantially equal to a power attenuation value of the delay unit 132. Consequently, the local oscillation signal S_{LO} received by the six-port demodulation element 140 and the radio frequency signal S_{RF} outputted from the delay unit 132 after time delay and power attenuation have equal power, able to optimize the signal-to-noise ratio of the six-port demodulation element 140.

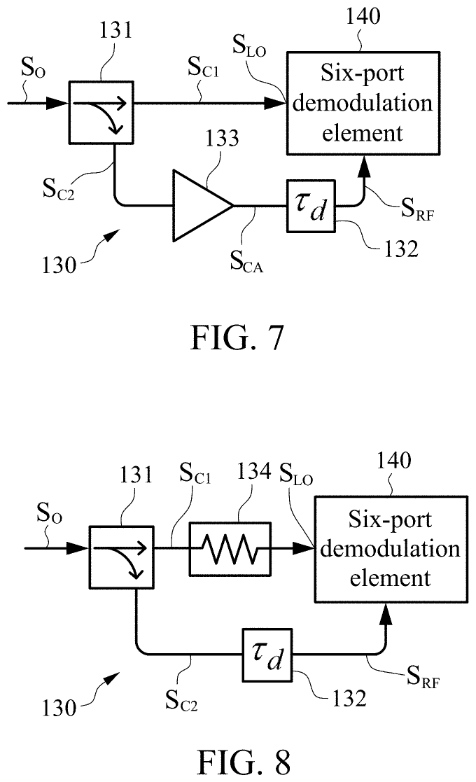

With reference to FIGS. 1 and 7, a second kind of architecture of the power coupling element 130 includes a directional coupler 131, a delay unit 132 and a power amplifier 133. The directional coupler 131 is electrically connected to the oscillation element 110 for receiving the oscillation signal S_{O} and configured to divide the oscillation signal S_{O} into a first coupling signal S_{C1} and a second coupling signal S_{C2} having the substantial same power. The first coupling signal S_{C1} is delivered to the six-port demodulation element 140 as the local oscillation signal S_{LO} directly. The power amplifier 133 is electrically connected to the direction coupler 131 and configured to receive and amplify the second coupling signal S_{C2} as an amplified coupling signal S_{CA}. The delay unit 132 is electrically connected to the power amplifier 133 for receiving the amplified coupling signal S_{CA} and configured to time-delay the amplified coupling signal S_{CA} as the radio frequency signal S_{RF} and deliver the radio frequency signal S_{RF} to the six-port demodulation element 140. Preferably, a gain value of the power amplifier 133 is substantially equal to a power attenuation value of the delay unit 132, so the radio frequency signal S_{RF} amplified by the power amplifier 133 and delayed/attenuated by the delay unit 132 has a power equal to that of the local oscillation signal S_{LO}. The signal-to-noise ratio of the six-port demodulation element 140 is optimized due to the local oscillation signal S_{LO} and the radio frequency signal S_{RF} received by the six-port demodulation element 140 have same power.

With reference to FIGS. 1 and 8, the power coupling element 130 includes a directional coupler 131, a delay unit 132 and an attenuator 134 in a third kind of architecture. The directional coupler 131 is electrically connected to the oscillation element 110 and configured to receive and divide the oscillation signal S_{O} into a first coupling signal S_{C1} and a second coupling signal S_{C2}. Powers of the first coupling signal S_{C1} and the second coupling signal S_{C2} are substantially identical. The attenuator 134, electrically connected to the directional coupler 131 to receive the first coupling signal S_{C1}, is configured to attenuate the first coupling signal S_{C1} to the local oscillation signal S_{LO} and then deliver the local oscillation signal S_{LO} to the six-port demodulation element 140. The delay unit 132 is electrically connected to the direction coupler 131 for receiving the second coupling signal S_{C2}, and configured to delay the second coupling signal S_{C2} in time as the radio frequency signal S_{RF} and deliver the radio frequency signal S_{RF} to the six-port demodulation element 140. Preferably, an attenuation value of the attenuator 134 is substantially equal to a power attenuation value of the delay unit 132 such that the local oscillation signal S_{LO} with attenuation from the attenuator 134 and the radio frequency signal S_{RF} with time-delaying and attenuation from the delay unit 132 have same power. And the local oscillation signal S_{LO} and the radio frequency signal S_{RF} having same power are configured to be received by the six-port demodulation element 140 to optimize the signal-to-noise ration.

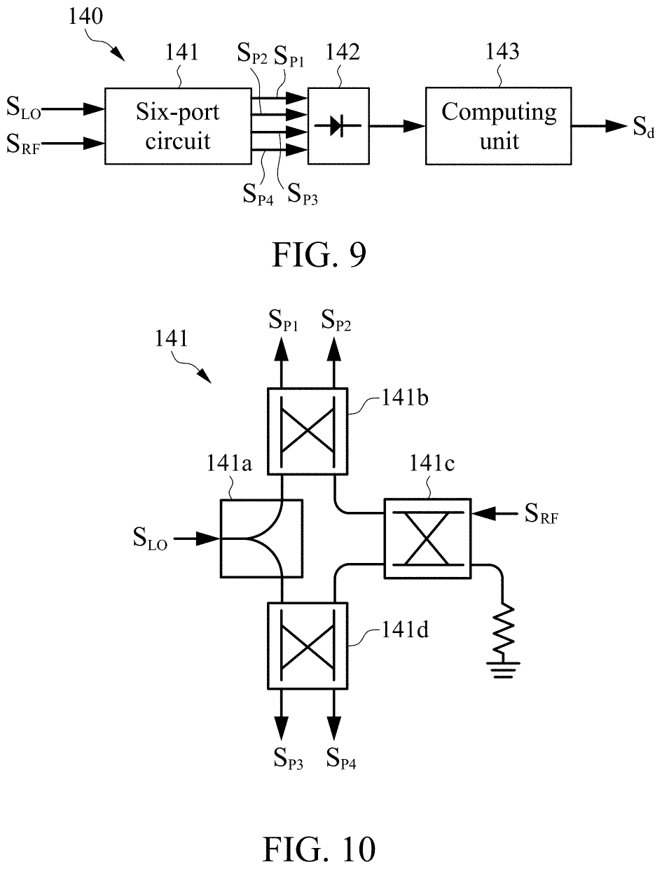

FIGS. 9 and 10 show the six-port demodulation element 140 of one embodiment of the present invention. According to FIGS. 1, 9 and 10, the six-port demodulation element 140 includes a six-port circuit 141, a power detect unit 142 and a computing unit 143. The six-port circuit 141 is electrically connected to the power coupling element 130 for receiving the local oscillation signal S_{LO} and the radio frequency signal S_{RF} and configured to output a plurality of output signals S_{P1}, S_{P2}, S_{P3}, S_{P4}. FIG. 10 is a circuit diagram illustrating the six-port circuit 141, and in this embodiment, the six-port circuit 141 consists of a power splitter 141a and three branch-line couplers 141b, 141c, 141d. The power splitter 141a is configured to receive and divide the local oscillation signal S_{LO} into two paths. The local oscillation signal S_{LO} of one path is delivered to the branch-line coupler 141b, and the local oscillation signal S_{LO} of the other path is delivered to the branch-line coupler 141d. One end of the branch-line coupler 141c is configured to receive the radio frequency signal S_{RF}, and another end of the branch-line coupler 141c is electrically connected to a resistor. After coupling, the branch-line coupler 141b is configured to output the output signals S_{P1}, P_{S2}, and the branch-line coupler 141d is configured to output the output signals S_{P3}, S_{P4}. With reference to FIG. 9, the power detect unit 142 is electrically connected to the six-port circuit 141 and configured to receive the output signals S_{P1}, S_{P2}, S_{P3}, S_{P4} to detect the power. In this embodiment, the power detect unit 142 includes a plurality of power detector (not shown) used to detect the power of each of the output signals S_{P1}, S_{P2}, S_{P3}, S_{P4}. The computing unit 143 is electrically connected to the power detect unit 142 and configured to demodulate the output signals S_{P1}, S_{P2}, S_{P3}, S_{P4} according the power level to output the demodulated signal S_{d}. The demodulated signal S_{d} contains the information of the movement of the subject O, and if the movement of the subject O relative to the six-port SIL radar 100 is caused by vital sign of the subject O, the demodulated signal S_{d} can be considered as vital sign signal of the subject O.

In the present invention, the power coupling element 130 and the six-port demodulation element 140 are provided to frequency-demodulate signals to extract the information regarding the movement of the subject O, as a result, the operating frequency of the six-port SIL radar 100 will not be restricted by demodulation element hardware. Additionally, the power coupling element 130 of the present invention is provided to allow the six-port demodulation element 140 to receive the local oscillation signal S_{LO} and the radio frequency signal S_{RF} having the same power for signal-to-noise ratio optimization of the six-port demodulation element 140.

The scope of the present invention is only limited by the following claims. Any alternation and modification without departing from the scope and spirit of the present invention will become apparent to those skilled in the art.

What is claimed is:

1. A six-port SIL radar, comprising:
an oscillation element configured to generate an oscillation signal;
a transceiver element electrically connected to the oscillation element, the transceiver element is configured to transmit the oscillation signal as a transmitted signal to a subject and receive a reflected signal from the subject as a detection signal, wherein the detection signal is configured to be injected into the oscillation element to allow the oscillation element to operate in a self-injection-locked state;
a power coupling element electrically connected to the oscillation element for receiving the oscillation signal, the power coupling element is configured to divide the oscillation signal into a local oscillation signal and a radio frequency signal; and
a six-port demodulation element electrically connected to the power coupling element for receiving the local oscillation signal and the radio frequency signal, the six-port demodulation element is configured to demodulate the local oscillation signal and the radio frequency signal to output a demodulated signal, wherein the local oscillation signal and the radio frequency signal received by the six-port demodulation element have the same power.

2. The six-port SIL radar in accordance with claim 1, wherein the oscillation element includes a voltage-controlled oscillator (VCO) and a coupler, the VCO is configured to output the oscillation signal, the coupler is electrically connected to the VCO for receiving the oscillation signal and configured to divide the oscillation signal into a first oscillation signal and a second oscillation signal, the transceiver element and the power coupling element are electrically connected to the coupler, the transceiver element is configured to receive the first oscillation signal from the coupler, the power coupling element is configured to receive the second oscillation signal from the coupler, and the detection signal received by the transceiver element is configured to be delivered to the coupler and coupled to the VCO by the coupler.

3. The six-port SIL radar i accordance with claim 1, wherein the oscillation element includes a voltage-controlled oscillator (VCO) configured to output the oscillation signal, and the transceiver element includes a transmit antenna and a receive antenna, the transmit antenna is electrically connected to the VCO for receiving the oscillation signal and configured to transmit the oscillation signal as the transmitted signal., the receive antenna is electrically connected to the VCO and configured to receive the reflected signal as the detection signal, and the detection signal is configured to injection lock the VCO.

4. The six-port SIL radar in accordance with claim 3, wherein the oscillation element further includes a coupler electrically connected to the VCO and the transmit antenna, the coupler is configured to divide the oscillation signal into a first oscillation signal and a second oscillation signal, the first oscillation signal is configured to be delivered to the transmit antenna, and the second oscillation signal is configured to be delivered to the power coupling element.

5. The six-port SIL radar in accordance with claim 4, wherein the oscillation element further includes a circulator electrically connected to the VCO, the coupler and the receive antenna, the oscillation signal from the VCO is configured to be delivered to the coupler via the circulator, and the detection signal received by the receive antenna is configured to be injected into the VCO via the circulator.

6. The six-port SIL radar in accordance with claim 1, wherein the power coupling element includes a directional coupler and a delay unit, the directional coupler is electrically connected to the oscillation element for receiving the oscillation signal and configured to divide the oscillation signal into a first coupling signal and a second coupling signal, the first coupling signal is configured to be delivered to the six-port demodulation element as the local oscillation signal, the delay unit is electrically connected to the directional coupler for receiving the second coupling signal and configured to time-delay the second coupling signal to the radio frequency signal and deliver the radio frequency signal to the six-port demodulation element.

7. The six-port SIL radar in accordance with claim 6, wherein the second coupling signal outputted from the directional coupler has a power higher than that of the first coupling signal outputted from the directional coupler, and a power difference between the second coupling signal and the first coupling signal is substantially equal to a power attenuation value of the delay unit.

8. The six-port SIL radar in accordance with claim 6, wherein the power coupling element further includes a power amplifier electrically connected to the directional coupler for receiving the second coupling signal, the power amplifier is configured to amplify the second coupling signal as an amplified coupling signal, the amplified coupling signal is configured to be delivered to the delay unit for time delay, and a gain value of the power amplifier is substantially equal to a power attenuation value of the delay unit.

9. The six-port SIL radar in accordance with claim 6, wherein the power coupling element further includes an attenuator electrically connected to the directional coupler for receiving the first coupling signal, the attenuator is configured to attenuate the first coupling signal, and a attenuation value of the attenuator is substantially equal to a power attenuation value of the delay unit.

10. The six-port SIL radar in accordance with claim 1, wherein the six-port demodulation element includes a six-port circuit, a power detect unit and a computing unit, the six-port circuit is electrically connected to the power coupling element for receiving the local oscillation signal and the radio frequency signal and configured to output a plurality of output signals, the power detect unit is electrically connected to the six-port circuit for receiving the output signals and configured to detect a power of each of the output signals, the computing unit is electrically connected to the power detect unit and configured to output the demodulated signal according to the power of each of the output signals.
